(19) United States
(12) Patent Application Publication
(10) Pub. No.: US 2026/0274279 A1
(43) Pub. Date: Sep. 17, 2026

(54) VEHICLE CONTROL APPARATUS, VEHICLE CONTROL METHOD, AND NON-TRANSITORY STORAGE MEDIUM STORING PROGRAM THEREOF

(71) Applicants: TOYOTA JIDOSHA KABUSHIKI KAISHA, Toyota-shi (JP); DENSO CORPORATION, Kariya-city (JP)

(72) Inventors: Masashi OISHI, Toyota-shi (JP); Ryo ISHII, Toyota-shi (JP); Takuya KAMINADE, Okazaki-shi (JP); Masaki IKAI, Toyota-shi (JP)

(73) Assignees: TOYOTA JIDOSHA KABUSHIKI KAISHA, Toyota-shi (JP); DENSO CORPORATION, Kariya-city (JP)

(21) Appl. No.: 19/533,887

(22) Filed: Feb. 9, 2026

(30) Foreign Application Priority Data
Mar. 17, 2025 (JP) 2025-042406

(51) Int. Cl. B60W 50/08

(52) U.S. Cl. CPC B60W 50/08; B60W 2520/28; B60W 2540/106; B60W 2540/12

(57) ABSTRACT

An ECU of a vehicle control apparatus determines whether a prerequisite condition is satisfied. The prerequisite condition is satisfied when an operation amount of an accelerator pedal becomes equal to or greater than a high operation amount threshold within a period from a first time point at which a rate of increase of the accelerator pedal operation amount becomes equal to or greater than an operation speed threshold to a second time point at which an elapsed time from the first time point reaches a rapid acceleration determination time threshold. The ECU determines whether a non-stopping condition to be satisfied when the vehicle does not stop within a predetermined vehicle non-stopping monitoring period is satisfied, and determines that an erroneous operation of the accelerator pedal has occurred when an erroneous operation determination condition that includes the prerequisite condition and the non-stopping condition becomes satisfied.

### TECHNICAL FIELD

The present disclosure relates to a vehicle control apparatus including a controller configured to determine whether an erroneous operation of an accelerator pedal has occurred, a vehicle control method for determining whether an erroneous operation of an accelerator pedal has occurred, and a non-transitory storage medium storing a program thereof.

### BACKGROUND

A conventional apparatus is configured to determine that an erroneous operation of an accelerator pedal has occurred when a prerequisite condition becomes satisfied in which an accelerator pedal operation amount (an operation amount of an accelerator pedal) becomes equal to or greater than a predetermined operation amount threshold within a period from a first time point at which an accelerator pedal operation speed (a rate of increase of the accelerator pedal operation amount) becomes equal to or greater than an operation speed threshold to a time point at which a predetermined time elapses since the first time point.

Furthermore, the conventional apparatus is configured not to determine that the erroneous operation of the accelerator pedal has occurred, even when the prerequisite condition becomes satisfied, if a braking-off elapsed time is shorter than a predetermined brake-off determination time threshold. The brake-off elapsed time is defined as a time duration from a time point at which a brake pedal is released to a time point at which the prerequisite condition becomes satisfied. This is because it is unlikely that a driver mistakenly operates the accelerator pedal instead of the brake pedal immediately after the driver has been depressing the brake pedal (refer to Japanese Patent No. 6806201).

### SUMMARY

However, the inventors have found that a driver may intentionally deeply depress the accelerator pedal such that the prerequisite condition becomes satisfied in situations such as cases 1 and 2 described below, even when the brake pedal has not been depressed for the brake-off determination time threshold or longer. In such situations, the conventional apparatus may determine that an erroneous operation of the accelerator pedal has occurred even though no erroneous operation of the accelerator pedal has actually occurred. As a result, an unnecessary driving force suppression control may be performed, or an unnecessary alert may be issued, so that a driver may feel uneasy.

(Case 1) A case in which a driver begins to depress the accelerator pedal while a brake-hold control that automatically applies a braking force to a vehicle is being carried out.

(Case 2) A case in which a driver begins to depress the accelerator pedal while the vehicle is stopped to attempt to climb over a step without depressing the brake pedal.

The present disclosure is directed to solving the problem described above, and an object thereof is to provide a vehicle control apparatus, a vehicle control method, and a program therefor that can reduce the likelihood of mistakenly determining a driver’s intentional accelerator pedal operation as an erroneous operation.

One of the embodiments of a vehicle control apparatus (hereinafter, referred to as a present disclosure apparatus) according to the present disclosure comprises a controller (10) configured to determine that an erroneous operation of an accelerator pedal (51) of a vehicle (VA) is performed when an erroneous operation determination condition becomes satisfied (S260), wherein the erroneous operation determination condition includes:

a prerequisite condition to be satisfied when an operation amount (AP) of the accelerator pedal and a rate of increase (dAP) of the accelerator pedal operation amount satisfy/meet a predetermined condition that is set to be satisfied when a predetermined rapid acceleration operation is performed (first and second conditions, S210 to S225); and

a non-stopping condition to be satisfied when the vehicle does not stop within a predetermined vehicle non-stopping monitoring period (P1) that is before a time point at which the prerequisite condition becomes satisfied (eighth condition, S255).

In this case, the prerequisite condition may be a condition to be satisfied when the operation amount of the accelerator pedal (AP) becomes equal to or greater than a high operation amount threshold (APth3) within a period from a first time point at which the rate of increase of the accelerator pedal operation amount (dAP) becomes equal to or greater than an operation speed threshold (dAPth) to a second time point (t2) at which an elapsed time (Ta) from the first time point reaches a rapid acceleration determination time threshold (Tath).

The inventors of the present disclosure have found, as a result of analyzing data obtained in the past, that, even when the above-described prerequisite condition becomes satisfied, a driver may intentionally strongly depress the accelerator pedal in a case where the vehicle is stopped in the predetermined period (i.e., the vehicle non-stopping monitoring period) that is before the time point at which the prerequisite condition becomes satisfied, as in the cases 1 and 2 described above. In view of the above, the controller of the above-described embodiment is configured to determine that the erroneous operation of the accelerator pedal is performed when the erroneous operation determination condition becomes satisfied, wherein the erroneous operation determination condition includes the prerequisite condition and the non-stopping condition to be satisfied when the vehicle does not stop within the vehicle non-stopping monitoring period. This can decrease the possibility that an operation of the accelerator pedal that is not erroneously performed is determined by the controller to be the erroneous operation of the accelerator pedal. As a result, for example, the possibility that an unnecessary driving force suppression control and/or an unnecessary alert are performed can be reduced.

In the above-described embodiment, the controller is configured to determine that the non-stopping condition is satisfied when a minimum value (Vmin) of a wheel speed of the vehicle is equal to or greater than a predetermined non-stopping determination speed threshold (Vmth) within a period (P1), serving as the vehicle non-stopping monitoring period, between a time point (t11) that is a first time (T1) before the prerequisite condition becomes satisfied and a time point (tz) at which the prerequisite condition becomes satisfied (S255).

Furthermore, in the above-described embodiment, the erroneous operation determination condition further includes a brake-off-continuation condition (i.e., third condition) to be satisfied when a brake pedal of the vehicle is not operated within a brake-off-required-period (Pb) between a time point (t12) that is a second time (T2) which is shorter than the first time (T1) before the prerequisite condition becomes satisfied and the time point (tz) at which the prerequisite condition becomes satisfied (S230).

Notably, in the above description, in order to facilitate understanding of the present disclosure, the constituent elements corresponding to those of embodiments which will be described later are accompanied by parenthesized symbols and/or names which are used in the embodiments; however, the constituent elements of the disclosure are not limited to those in the embodiments defined by the symbols and/or names. The present disclosure covers a vehicle control method, and a non-transitory storage medium storing a program thereof.

### BRIEF DESCRIPTION OF THE DRAWINGS

FIG. 1 is a schematic diagram of a vehicle control apparatus (present apparatus) according to an embodiment of the present disclosure.

FIG. 2 is a routine executed by a CPU of the present apparatus.

FIG. 3 is a timing chart for describing an operation of the present apparatus.

FIG. 4 is a routine executed by the CPU of the present apparatus.

FIG. 5 is a look-up table which the CPU of the present apparatus refers to.

FIG. 6 is a look-up table which the CPU of the present apparatus refers to.

### DETAILED DESCRIPTION

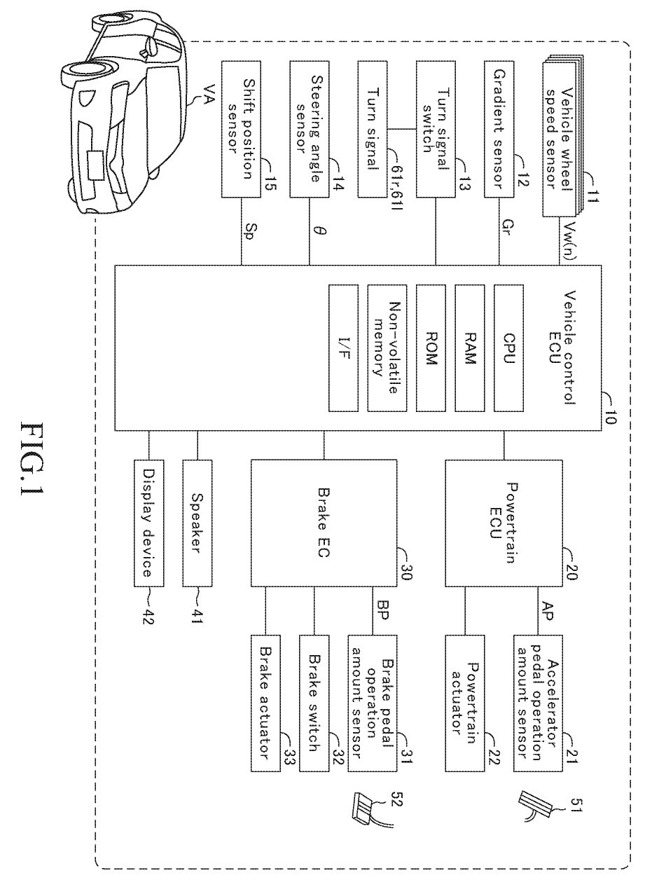

A vehicle control apparatus (hereinafter, referred to as an "present apparatus") according to an embodiment of the present disclosure comprises elements shown in FIG. 1 and is applied to and/or mounted on a vehicle VA.

In the present specification, an “ECU” refers to an electronic control device (i.e., an Electronic Control Unit), that includes, as a main component, a microcomputer having a CPU (a processor) and memories. The ECU may sometimes be referred to as a “controller” or a “computer”. The elements including a plurality of ECUs shown in FIG. 1 are connected to each other via Controller Area Network (CAN) so as to be capable of exchanging information with each other. Some or all of the ECUs shown in FIG. 1 may be integrated into a single ECU. The microcomputer includes a CPU, a RAM, a ROM which is a non-transitory storage medium storing programs, and an interface. The microcomputer implements various functions by executing instructions (programs, routines) stored in the ROM.

The vehicle control ECU 10 is connected to sensors and switches described below and configured to receive their detection signals or output signals.

The wheel speed sensor 11 is configured to output a signal indicative of a speed (i.e., a wheel speed Vw(n); n is one of FL, FR, RL, or RR) of a front left wheel FL, a front right wheel FR, a rear left wheel RL, and a rear right wheel RR. The vehicle control ECU 10 uses an average of wheel speeds Vw(n) as a speed (vehicle speed Vs) of the vehicle VA.

The gradient sensor 12 is configured to output a signal indicative of a gradient Gr of a traveling road surface in a vehicle front-rear direction. The gradient Gr assumes a positive value when the vehicle VA is traveling on an uphill road.

The turn signal switch 13 is configured to output a signal to turn on (blink) a right turn signal 61r when a turn signal lever operated by a driver is at a first position and a signal to turn on (blink) a left turn signal 61l when the turn signal lever is at a second position.

The steering angle sensor 14 is configured to output a signal indicative of a steering angle θ which is a rotational angle of the steering wheel of the vehicle VA.

The shift position sensor 15 is configured to output a signal indicative of a shift position Sp of a power transmitting device such as a transmission of the vehicle VA. The shift position Sp includes a driving position (e.g., a driving range including a forward range D and a reverse range R) for driving the vehicle VA and a non-driving position (e.g., a non-driving range including a parking range P and a neutral range N).

The powertrain ECU 20 is connected to the accelerator pedal operation amount sensor 21. The accelerator pedal operation amount sensor 21 is configured to output a signal indicative of an operation amount AP (i.e., an accelerator opening ratio [%]) of the accelerator pedal 51 which is an acceleration operation element operated by the driver to accelerate the vehicle VA. The powertrain ECU 20 obtains the operation amount AP of the accelerator pedal 51 from the accelerator pedal operation amount sensor 21. The operation amount AP of the accelerator pedal 51 is also referred to as an accelerator pedal operation amount AP.

The powertrain ECU 20 is connected to the powertrain actuator 22 and configured to drive the actuator 22. The actuator 22 is configured to alter a torque generated by the driving device (driving source) of the vehicle VA. The torque generated by the driving device is transmitted to driving wheels through the power transmitting device. Accordingly, the powertrain ECU 20 is configured to control a driving force of the vehicle VA.

When the driving device of the vehicle VA is a gasoline fueled internal combustion engine, the actuator 22 is, for example, a throttle valve actuator configured to alter an opening degree of the throttle valve. The vehicle VA may be an electric vehicle. In such a case, the actuator 22 is an inverter configured to alter a torque generated by an electric motor. The vehicle VA may be a hybrid vehicle. In such a case, the actuator 22 includes the inverter for the electric motor and the throttle valve actuator for the internal combustion engine.

The brake ECU 30 is connected to the brake pedal operation amount sensor 31 and the brake switch 32 and obtains the signals from them. The brake pedal operation amount sensor 31 is configured to output a signal indicative of an operation amount BP of the brake pedal 52. The operation amount BP of the brake pedal 52 is also referred to as a brake pedal operation amount BP. The brake switch 32 is configured to output an off signal when the brake pedal 52 is not operated (i.e., when the brake pedal 52 is off). The brake switch 32 is configured to output an on signal when the brake pedal 52 is operated (i.e., when the brake pedal 52 is on).

The brake ECU 30 is connected to the brake actuator 33. The brake ECU 30 is configured to drive the brake actuator 33 so as to control frictional brake devices, each of which is disposed on respective wheels of the vehicle VA, to alter a frictional braking force applied to the vehicle VA. That is, the brake ECU 30 is configured to alter a braking force applied to the vehicle VA.

The vehicle control ECU 10 is connected to the speaker 41 and the display device 42.

### Operation

When the accelerator pedal 51 is mistakenly operated instead of the brake pedal 52, a prerequisite condition is satisfied. The prerequisite condition is a condition to be satisfied when an operation amount (AP) of the accelerator pedal becomes equal to or greater than a predetermined operation amount threshold (APth3) within a period from a first time point at which an operation speed (i.e., a rate of increase) of the accelerator pedal becomes equal to or greater than an operation speed threshold to a second time point at which a predetermined time (Tath) elapses from the first time point. That is, the prerequisite condition is a predetermined condition that is met by both an operation amount of the accelerator pedal and a rate of increase of the operation amount of the accelerator pedal, when a predetermined rapid acceleration operation is performed.

It is unlikely that, within a short period after the driver releases the brake pedal 52, a driver mistakenly operates the accelerator pedal 51 strongly instead of the brake pedal 52. In other words, an erroneous operation of the accelerator pedal 51 tends to occur when a non-operation period in which the brake pedal 52 is not operated is long. In view of the above, the present apparatus is configured not to determine that the erroneous operation of the accelerator pedal has occurred even when the prerequisite condition becomes satisfied, if a time (i.e., a brake-off elapsed time) after the brake pedal 52 becomes off (or is released) is less than a predetermined time referred to as a brake-off determination time threshold.

However, the inventors have found, as a result of analyzing data obtained in the past, that, in situations such as cases 1 and 2 described below, a driver may intentionally strongly depress the accelerator pedal 51 without mistakenly recognizing the accelerator pedal 51 as the brake pedal 52, thereby causing the prerequisite condition to become satisfied, even when the driver has not depressed the brake pedal 52 for the brake-off determination time threshold or longer.

(Case 1) A case in which a driver begins to depress the accelerator pedal 51 while the vehicle VA is fully stopped by a brake-hold control that automatically applies a braking force to the vehicle.

(Case 2) A case in which a driver begins to depress the accelerator pedal 51 when the driver has not depressed the brake pedal 52 but the vehicle is stopped because the vehicle is attempting to climb over a step.

In view of the above, even when the prerequisite condition becomes satisfied and the time (i.e., the brake-off elapsed time) of a period in which the brake pedal 52 has not been operated is equal to or longer than the brake-off determination time threshold, the present apparatus is configured not to determine that the erroneous operation of the accelerator pedal has occurred if the vehicle VA is determined to have been fully stopped in a predetermined period referred to as a vehicle non-stopping monitoring period before the prerequisite condition becomes satisfied. The vehicle non-stopping monitoring period is a period starting from a time point that is a predetermined monitoring time before the satisfaction time point of the prerequisite condition to the satisfaction time point of the prerequisite condition. The predetermined monitoring time is also referred to as a first time T1, for convenience. Thus, a duration of the vehicle non-stopping monitoring period is equal to the first time T1.

This can reduce the possibility that the driver feels uneasy, because the acceleration suppression control and/or generation of the alert are not performed when the driver intentionally depresses the accelerator pedal 51, such as in cases including the case 1 and the case 2.

### Specific Operation

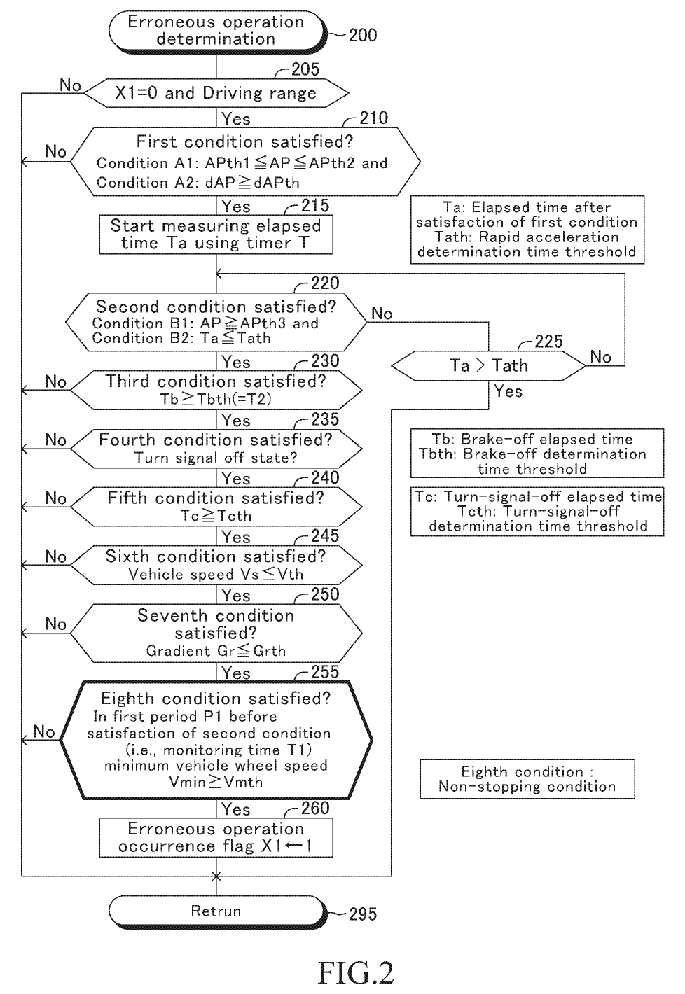

The CPU of the vehicle control ECU 10 (hereinafter, simply referred to as a "CPU") executes routines shown in flowcharts in FIGS. 2 to 4, each time a predetermined time elapses. It should be noted that a "step" may be expressed as "S".

When an appropriate time point comes, the CPU starts processing from S200 in FIG. 2, and proceeds to S205. At S205, the CPU determines whether both a value of an erroneous operation occurrence flag X1 is "0" and the shift position Sp is at the driving range. When both the value of the erroneous operation occurrence flag X1 is "0" and the shift position Sp is at the driving range, the CPU proceeds from S205 to S210 to determine whether a first condition described below is satisfied. Specifically, at S210, the CPU determines that the first condition is satisfied when both a condition A1 and a condition A2, described below, are satisfied. It should be noted that the CPU may determine that the first condition is satisfied when at least the condition A2 is satisfied.

### First Condition

Condition A1: This condition is satisfied when the accelerator pedal operation amount AP is equal to or greater than a first operation amount threshold APth1 and less than a second operation amount threshold APth2.

Condition A2: This condition is satisfied when the accelerator pedal operation speed (the increase rate of the accelerator pedal operation amount) dAP (i.e., an increase amount of the accelerator pedal operation amount AP per unit time) is equal to or greater than an operation speed threshold dAPth.

When the first condition is satisfied, the CPU proceeds from S210 to S215 to start measuring an elapsed time Ta using a timer T. That is, the value of the timer T indicates the elapsed time Ta from a time point (first time point t1) at which the first condition becomes satisfied. Subsequently, at S220, the CPU determines whether or not the second condition is satisfied. The second condition is satisfied when both a condition B1 and a condition B2, described below, are satisfied.

### Second Condition

Condition B1: This condition is satisfied when the accelerator pedal operation amount AP is equal to or greater than a third operation amount threshold APth3. The third operation amount threshold APth3 is greater than the second operation amount threshold APth2, and is set at a value (e.g., accelerator opening ratio 90 [%]) equal to or greater than a lower limit (e.g., accelerator opening ratio 80 [%]) of a high opening degree area. The third operation amount threshold APth3 may also be referred to as a high operation amount threshold.

Condition B2: This condition is satisfied when the elapsed time Ta at a time point when the condition B1 becomes satisfied is equal to or less than a rapid acceleration determination time threshold Tath (e.g., 0.5s). Therefore, the second condition becomes satisfied when the condition B1 becomes satisfied before a second time point at which the elapsed time Ta from the first time point at which the first condition becomes satisfied reaches or exceeds the rapid acceleration determination time threshold Tath.

In this manner, the second condition becomes satisfied only when the first condition is satisfied. The second condition together with the first condition is referred to as a "prerequisite condition for accelerator pedal erroneous operation determination" or a "prerequisite condition".

When the second condition is not satisfied, the CPU proceeds from S220 to S225 to determine whether the elapsed time Ta is greater than the rapid acceleration determination time threshold Tath. When the elapsed time Ta is equal to or less than the rapid acceleration determination time threshold Tath, the CPU returns from S225 to S220. In contrast, when the elapsed time Ta becomes greater than the rapid acceleration determination time threshold Tath, the CPU directly proceeds from S225 to S295 to terminate the present routine tentatively. In this case, it is determined that the accelerator pedal erroneous operation has not occurred.

When the second condition (i.e., the prerequisite condition) becomes satisfied, the CPU proceeds from S220 to S230 - S250 to determine whether third to seventh conditions are satisfied. It should be noted that, when the CPU makes a "No" determination at any of the steps from S220 to S250, the CPU directly proceeds to S295 from the step at which the CPU makes the "No" determination so as to terminate the present routine tentatively.

### Third Condition

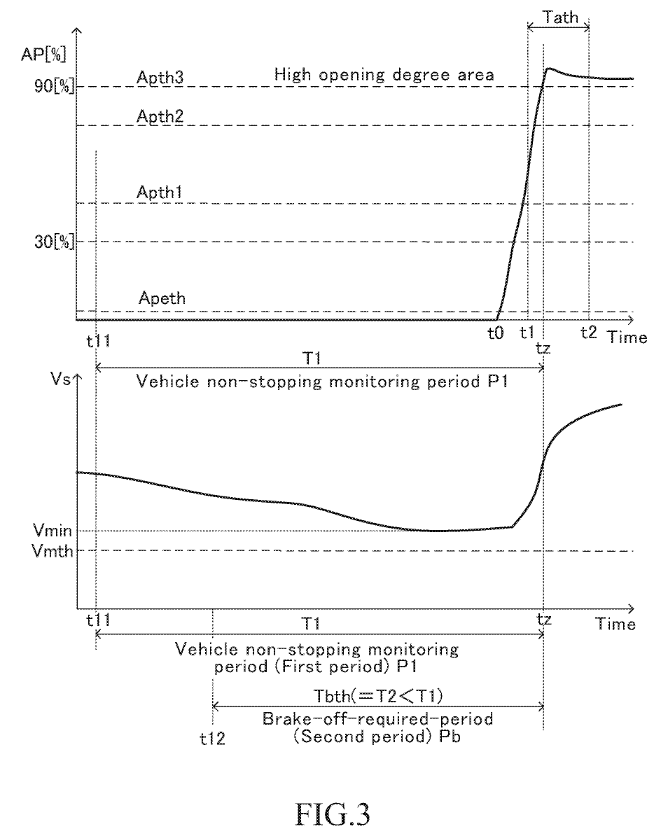

This condition is satisfied when an elapsed time Tb from a time point at which the CPU receives the off signal from the brake switch 32 is equal to or greater than a brake-off determination time threshold Tbth (S230). The length of the brake-off determination time threshold Tbth may be referred to as a "second time T2", for convenience. That is, the third condition becomes satisfied when the brake switch continues to generate the off signal over a brake-off-required-period Pb that is a period from a time point (t12) that is the second time T2 before the time point at which both of the first and second conditions are satisfied (i.e., the prerequisite condition satisfaction time point (tz)) to the prerequisite condition satisfaction time point (tz) (refer to FIG. 3). The third condition is also referred to as a brake-off-continuation condition.

### Fourth Condition

This condition is satisfied when a state of the turn signal switch 13 indicates that both of the left turn signal 61l and the right turn signal 61r are off (S235).

### Fifth Condition

This condition is satisfied when a turn-signal-off elapsed time Tc is equal to or greater than a turn-signal-off determination time threshold Tcth (S240). The turn-signal-off elapsed time Tc is an elapsed time of a state in which both of the left turn signal 61l and the right turn signal 61r are kept off since an off time point at which both of the left turn signal 61l and the right turn signal 61r are turned off from a state in which either one of the left turn signal 61l and the right turn signal 61r is on.

### Sixth Condition

This condition is satisfied when the vehicle speed Vs is equal to or less than a vehicle speed threshold Vth representing a low speed (S245).

### Seventh Condition

This condition is satisfied when the gradient Gr is equal to or less than a positive gradient threshold Grth (S250). That is, this condition is satisfied when the vehicle VA is not traveling on a steep uphill road.

When all of the conditions from the third to seventh conditions are satisfied, the CPU makes a "Yes" determination at each of the steps from S230 to S250 so as to proceed to S255. At S255, the CPU determines whether an eighth condition described below is satisfied. The eighth condition may also be referred to as a "non-stopping condition".

### Eighth Condition

This condition is satisfied when a minimum value (i.e., a minimum wheel speed) Vmin in the vehicle non-stopping monitoring period P1 is equal to or greater than a vehicle non-stopping determination speed threshold Vmth. The vehicle non-stopping monitoring period P1 is a period from the time point (refer to the time point t11 in FIG. 3) that is "the first time T1 which is a predetermined vehicle non-stopping monitoring time" before the time point at which both of the first condition and the second condition become satisfied (i.e., the satisfaction time point of the prerequisite condition, refer to the time point tz in FIG. 3) to the satisfaction time point of the prerequisite condition (refer to the time point tz in FIG. 3). The vehicle non-stopping determination speed threshold Vmth may also be simply referred to as a non-stopping determination speed threshold Vmth.

The vehicle non-stopping determination speed threshold Vmth is set at a value (e.g., 1km/h) corresponding to a value slightly greater than "0".

The first time T1 which is a time length of the vehicle non-stopping monitoring period P1 is set at a time longer than the second time T2 which is a time length of the brake-off-required-period Pb. Accordingly, in order for the eighth condition to become satisfied, the minimum wheel speed Vmin at least in the brake-off-required-period Pb must be equal to or greater than the vehicle non-stopping determination speed threshold Vmth.

When the eighth condition is satisfied, the CPU proceeds from S255 to S260 to set the value of the erroneous operation occurrence flag X1 to "1". That is, the CPU determines that the erroneous operation of the accelerator pedal (i.e., erroneous-depression operation) has occurred. This causes the acceleration suppression control and the alert to be performed as described later. Thereafter, the CPU proceeds to S295 to terminate the present routine tentatively.

In contrast, when the eighth condition is not satisfied, the CPU directly proceeds from S255 to S295. In this case, the process of S260 is not performed, and thus, the value of the erroneous operation occurrence flag X1 is maintained at "0". In other words, the CPU determines that the erroneous operation of the accelerator pedal has not occurred. Thus, in this case, the acceleration suppression control and the alert, described later, are not performed.

It should be noted that, if the shift position Sp is not at the driving range or if the value of the erroneous operation occurrence flag X1 is "1" when the CPU proceeds to S205, the CPU directly proceeds from S205 to S295. Furthermore, when the first condition is not satisfied, the CPU directly proceeds from S210 to S295.

### Driving Force Control

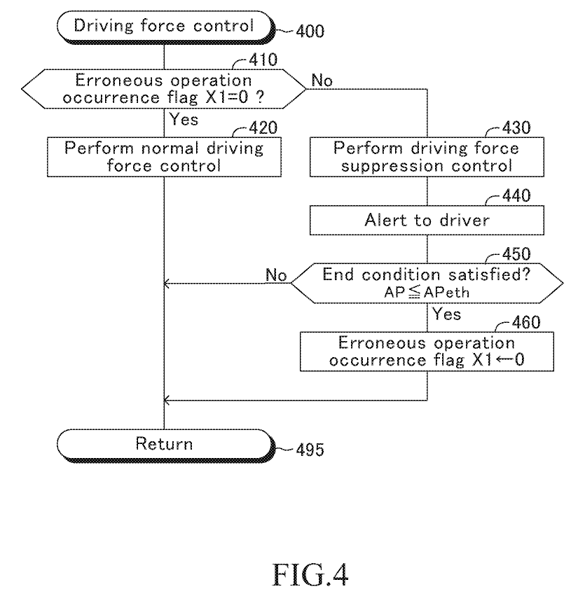

When an appropriate time point comes, the CPU starts processing from S400 in FIG. 4, and proceeds to S410. At S410, the CPU determines whether the value of the erroneous operation occurrence flag X1 is "0". When the value of the erroneous operation occurrence flag X1 is "0", the CPU proceeds from S410 to S420 to perform a normal driving force control described below.

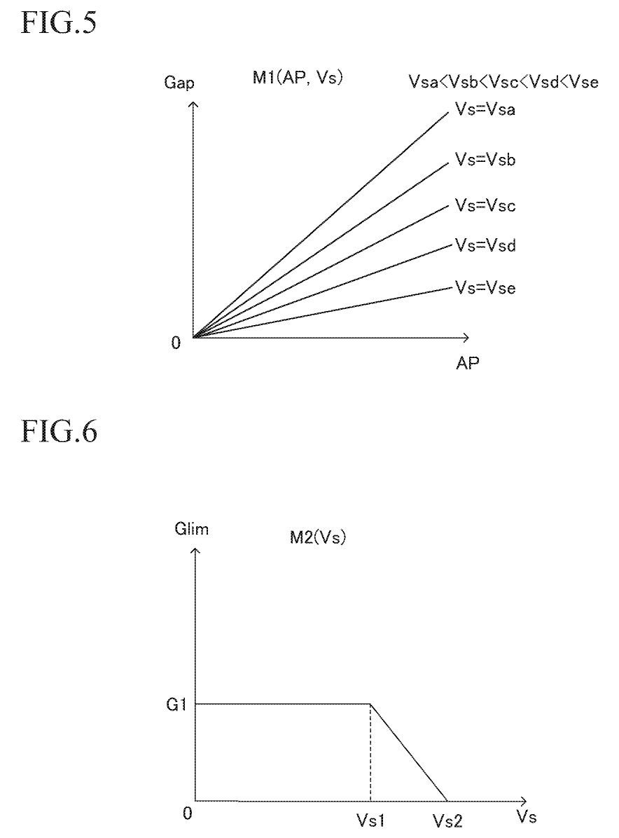

Specifically, the CPU obtains a required acceleration Gap by applying the actual accelerator pedal operation amount AP and the actual vehicle speed Vs to a look-up table M1(AP, Vs) shown in FIG. 5. According to the look-up table M1(AP, Vs), the required acceleration Gap becomes greater as the accelerator pedal operation amount AP becomes greater, and the required acceleration Gap becomes greater as the vehicle speed Vs becomes lower. The CPU controls the driving force through the powertrain ECU 20 in such a manner that an actual acceleration (i.e., time differentiation of the vehicle speed Vs, dVs/dt) coincides with the required acceleration Gap. Thereafter, the CPU proceeds to S495 to terminate the present routine tentatively.

In contrast, when the value of the erroneous operation occurrence flag X1 is "1" (that is, when the CPU determines that the erroneous operation of the accelerator pedal (i.e., erroneous-depression operation) has occurred), the CPU proceeds from S410 to S430 to perform the driving force suppression control described below.

Specifically, the CPU obtains an upper limit acceleration Glim corresponding to the vehicle speed Vs by applying the actual vehicle speed Vs to a look-up table M2(Vs) shown in FIG. 6. As shown in FIG. 6, the upper limit acceleration Glim is set at a constant acceleration G1 when the vehicle speed Vs is between 0 and Vs1. The upper limit acceleration Glim becomes smaller toward 0 as the vehicle speed Vs becomes greater from Vs1. The upper limit acceleration Glim is set at 0 when the vehicle speed Vs is equal to or greater than Vs2, which is greater than Vs1.

The CPU sets a target acceleration Gtgt to either the required acceleration Gap or the upper limit acceleration Glim, whichever is smaller. The CPU controls the driving force through the powertrain ECU 20 in such a manner that the actual acceleration coincides with the target acceleration Gtgt. It should be noted that the CPU may set the target acceleration Gtgt to a value obtained by multiplying the required acceleration Gap by a coefficient α which is greater than 0 and smaller than 1.

Next, the CPU proceeds to S440 and generates an alert using the speaker 41 and the display device 42 to notify the driver of the vehicle VA that the accelerator pedal is being erroneously operated and to prompt the driver to stop operating the accelerator pedal. In addition, the CPU may notify the driver using the speaker 41 and the display device 42 that the driving force suppression control is being performed.

Subsequently, at S450, the CPU determines whether or not an end condition of the driving force suppression control is satisfied. The end condition of the driving force suppression control is satisfied when the accelerator pedal operation amount AP becomes equal to or smaller than an end threshold APeth. The end threshold APeth is set at a value which is smaller than the first operation amount threshold APth1 such that the accelerator pedal operation amount AP can be determined to be substantially equal to 0 when the accelerator pedal operation amount AP becomes equal to or smaller than the end threshold APeth.

When the accelerator pedal operation amount AP has not become equal to or smaller than the end threshold APeth, the CPU directly proceeds from S450 to S495 to terminate the present routine tentatively. Accordingly, in this case, the erroneous operation occurrence flag X1 is maintained at "1" and the driving force suppression control continues to be performed.

In contrast, when the accelerator pedal operation amount AP has become equal to or smaller than the end threshold APeth, the CPU proceeds from S450 to S460 to set the value of the erroneous operation occurrence flag X1 to "0". Thereafter, the CPU proceeds to S495. As a result, the driving force suppression control and the above-described alert are terminated, and the normal driving force control is resumed.

As has been described above, according to the embodiment of the present disclosure, the possibility of determining that the accelerator pedal operation that is not an erroneous operation of the accelerator pedal in the situation where the vehicle VA stops while the driver does not operate the brake pedal as the erroneous operation of the accelerator pedal can be decreased. It should be noted that the present disclosure is not limited to the above-described embodiment and may adopt various modified examples within the scope of the present disclosure.

For example, the prerequisite condition for accelerator pedal erroneous operation determination is not limited to the condition to be satisfied when the above-described first condition and the above-described second condition are satisfied. That is, the prerequisite condition for accelerator pedal erroneous operation determination may be a condition that is satisfied when both the accelerator pedal operation amount AP and the rate of increase dAP of the accelerator pedal operation amount meet a predetermined condition that is set to be satisfied when a predetermined rapid acceleration operation is performed. For example, the CPU may determine that the prerequisite condition for accelerator pedal erroneous operation determination becomes satisfied when an average of the rate of increase dAP of the accelerator pedal operation amount for a certain period is equal to or greater than a predetermined rate of increase average threshold dAPaveth and the accelerator pedal operation amount AP becomes equal to or greater than the high operation amount threshold APth3 in that certain period.

For example, in the embodiment, the satisfaction of the third to seventh conditions is not an essential requirement for determining that an erroneous operation of the accelerator pedal has occurred. In other words, some or all of the steps from S230 to S250 may be omitted. Furthermore, the CPU may add a condition other than any of the third to seventh conditions to the condition used to determine that an erroneous operation of an accelerator pedal has occurred. Furthermore, the present disclosure can be applied to a vehicle that is in a state in which a driving mode has transitioned from autonomous driving to driving by a driver in an autonomous vehicle.

What is claimed is:

1. A vehicle control apparatus comprising a controller configured to determine that an erroneous operation of an accelerator pedal of a vehicle is performed when an erroneous operation determination condition becomes satisfied, wherein said erroneous operation determination condition includes:
a prerequisite condition to be satisfied when an operation amount of said accelerator pedal and a rate of increase of said accelerator pedal operation amount meet a predetermined condition that is set to be satisfied when a predetermined rapid acceleration operation is performed; and
a non-stopping condition to be satisfied when said vehicle does not stop within a predetermined vehicle non-stopping monitoring period that is before a time point at which said prerequisite condition becomes satisfied.

2. The vehicle control apparatus according to claim 1, wherein
said controller is configured to determine that said non-stopping condition is satisfied when a minimum value of a wheel speed of said vehicle is equal to or greater than a predetermined non-stopping determination speed threshold within a period, serving as said vehicle non-stopping monitoring period, between a time point that is a first time before said prerequisite condition becomes satisfied and a time point at which said prerequisite condition becomes satisfied.

3. The vehicle control apparatus according to claim 2, wherein
said erroneous operation determination condition further includes a brake-off-continuation condition to be satisfied when a brake pedal of said vehicle is not operated within a brake-off-required-period between a time point that is a second time which is shorter than said first time before said prerequisite condition becomes satisfied and said time point at which said prerequisite condition becomes satisfied.

4. The vehicle control apparatus according to claim 3, wherein
said prerequisite condition is a condition to be satisfied when said operation amount of said accelerator pedal (AP) becomes equal to or greater than a high operation amount threshold (APth3) within a period from a first time point at which said rate of increase of said accelerator pedal operation amount (dAP) becomes equal to or greater than an operation speed threshold (dAPth) to a second time point (t2) at which an elapsed time (Ta) from said first time point reaches a rapid acceleration determination time threshold (Tath).

5. A vehicle control method comprising a determining step of determining that an erroneous operation of an accelerator pedal of a vehicle is performed when an erroneous operation determination condition becomes satisfied, wherein said erroneous operation determination condition includes:
a prerequisite condition to be satisfied when an operation amount of said accelerator pedal and a rate of increase of said accelerator pedal operation amount satisfy a predetermined condition that is set to be satisfied when a predetermined rapid acceleration operation is performed; and
a non-stopping condition to be satisfied when said vehicle does not stop within a predetermined vehicle non-stopping monitoring period that is before a time point at which said prerequisite condition becomes satisfied.

6. The vehicle control method according to claim 5, wherein said determining step includes a step of determining that said non-stopping condition is satisfied when a minimum value of a wheel speed of said vehicle is equal to or greater than a predetermined non-stopping determination speed threshold within a period, serving as said vehicle non-stopping monitoring period, between a time point that is a first time before said prerequisite condition becomes satisfied and a time point at which said prerequisite condition becomes satisfied.

7. The vehicle control method according to claim 6, wherein
said erroneous operation determination condition further includes a brake-off-continuation condition to be satisfied when a brake pedal of said vehicle is not operated within a brake-off-required-period between a time point that is a second time which is shorter than said first time before said prerequisite condition becomes satisfied and said time point at which said prerequisite condition becomes satisfied.

8. The vehicle control method according to claim 7, wherein
said prerequisite condition is a condition to be satisfied when said operation amount of said accelerator pedal (AP) becomes equal to or greater than a high operation amount threshold (APth3) within a period from a first time point at which said rate of increase of said accelerator pedal operation amount (dAP) becomes equal to or greater than an operation speed threshold (dAPth) to a second time point (t2) at which an elapsed time (Ta) from said first time point reaches a rapid acceleration determination time threshold (Tath).

9. A non-transitory storage medium storing a program, said program causing a computer to implement a determining step of determining that an erroneous operation of an accelerator pedal of a vehicle is performed when an erroneous operation determination condition becomes satisfied, wherein said erroneous operation determination condition includes:
a prerequisite condition to be satisfied when an operation amount of said accelerator pedal and a rate of increase of said accelerator pedal operation amount satisfy a predetermined condition that is set to be satisfied when a predetermined rapid acceleration operation is performed; and
a non-stopping condition to be satisfied when said vehicle does not stop within a predetermined vehicle non-stopping monitoring period that is before a time point at which said prerequisite condition becomes satisfied.
